(19) United States
(12) Patent Application Publication
(10) Pub. No.: US 2024/0173780 A1
(43) Pub. Date: May 30, 2024

(54) DEVICE FOR CUTTING AND/OR BORING OUT DEBILITATED AND/OR BULGING PIPE LINER, AND METHOD OF MAKING AND USING SAME

(71) Applicant: Eduardo Gomez, Hialeah, FL (US)

(72) Inventor: Eduardo Gomez, Hialeah, FL (US)

(21) Appl. No.: 18/514,670

(22) Filed: Nov. 20, 2023

Related U.S. Application Data
(60) Provisional application No. 63/385,070, filed on Nov. 28, 2022.

(51) Int. Cl. B23B 51/00

(52) U.S. Cl. CPC B23B 51/0018

(57) ABSTRACT

A device configured to bore out a section of underground pipe or an interior liner therein without the need to dig out the section of pipe can include a plurality of arms extending radially outwardly from a central shaft. The central shaft can be configured to attach to a tool or a robot. The device can also at least one cutting device extending radially outwardly from the central shaft. The at least one cutting device can be configured to move in unison with the central shaft. rotation of the central shaft can cause the at least one cutting device to contact and cut an interior surface of the underground pipe or the interior liner thereof.

### CROSS-REFERENCE TO RELATED APPLICATION

The present application claims priority to U.S. Provisional Patent Application No. 63/385,070, titled “DEVICE FOR CUTTING AND/OR BORING OUT DEBILITATED AND/OR BULGING PIPE LINER, AND METHOD OF MAKING AND USING SAME” and filed Nov. 28, 2022, the disclosure of which is hereby incorporated by reference in its entirety.

### FIELD

The presently disclosed technology relates generally to an apparatus for fixing and/or repairing debilitated pipe and/or bulging newly installed pipe liner, and method of making and using same. Optionally, the apparatus can be coupled to existing or prior art robotic drills or tools.

### BACKGROUND

It is known to insert a liner, sleeve, or sock into a debilitated pipe (e.g., wastewater pipes made of cast iron and/or other materials) to line the interior of at least a portion of the pipe to fix or repair the pipe. This process can significantly extend the useful life of the old or existing pipe. One example is INSITUFORM® cured-in-place pipe (CIPP) technology by AEGION of St. Louis, Missouri.

The liner begins as soft, flexible, and/or malleable, and then hardens into a strong, fiberglass-type material once in position. This leaves the inside of the pipe clean and clear for use. The liner allows cities or municipalities to fix run-down pipes without having to dig the pipes out of the ground and replace the debilitated portions, or even entire lengths, with new pipe. The cost and time savings can be tremendous.

Despite the numerous benefits of the above technology, there are drawbacks or challenges associated with it. In some instances, the liner incorrectly or prematurely hardens, cures, or otherwise fails or deteriorates inside the pipe. For example, the liner can undesirably bulge into the interior of the pipe. These bulges are commonly called “lifts”, which do not allow for proper drainage from the pipe. In these scenarios, the liner either needs to be removed so a new or different liner can be installed or that section of the pipe needs to be replaced. In the scenario where the liner is removed, the affected portion of the pipe liner can be etched out, which is a tedious, cumbersome, and time-consuming process. In the scenario where the pipe is replaced, the portion of the pipe is dug out and replaced with new pipe, which is an expensive proposition.

### SUMMARY

The presently disclosed technology overcomes the above and other challenges in the prior art.

In one embodiment, the presently disclosed technology is directed to a device, which optionally can be coupled to existing or prior art robotic equipment, that bores out a section of underground pipe and/or interior liner thereof without the need to dig out the section of pipe. This invention thereby saves time and money.

In another embodiment, the presently disclosed technology is directed to a device configured to bore out a section of underground pipe and/or interior liner thereof without the need to dig out the section of pipe, where the device can include a plurality of arms extending radially outwardly from a central shaft. The central shaft can be configured to attach to a tool, such as existing robotic equipment with or without cameras. The device can include a plurality of cutting devices (e.g., blades) extending outwardly from the central shaft at one end of the device. Each cutting device can be configured to move in unison with the central shaft. Rotation of the central shaft can cause each cutting device to contact, cut, and/or remove an interior surface of underground pipe or an interior liner thereof.

Optionally, each arm helps to properly position the device within the pipe. Each arm can be fixed or automatically adjustable to the radius of the pipe and/or imperfections in the pipe.

### BRIEF DESCRIPTION OF THE SEVERAL VIEWS OF THE DRAWINGS

The foregoing summary, as well as the following detailed description of the presently disclosed technology, will be better understood when read in conjunction with the appended drawings. For the purpose of illustrating the presently disclosed technology, there are shown in the drawings various illustrative embodiments. It should be understood, however, that the presently disclosed technology is not limited to the precise arrangements and instrumentalities shown. In the drawings:

FIG. 1 is a perspective view of a device according to an embodiment of the presently disclosed technology attached to a tool, such as an existing robotic tool or a rotary tool;

FIG. 2 is another perspective view of the device and a portion of the existing robotic tool or rotary tool of FIG. 1;

FIG. 3 is another perspective view of the device of FIG. 1;

FIG. 4 is a magnified view of a portion of the device of FIG. 1;

FIG. 5 is still another perspective view of the device of FIG. 1;

FIG. 6 is a perspective view of the device of FIG. 1 shown within a portion of pipe that was previously lined with an interior liner;

FIG. 7A is a front cross-sectional view of the device of FIG. 1;

FIG. 7B is a front cross-sectional view of a first portion of the device of FIG. 1;

FIG. 7C is a front cross-sectional view of a second portion of the device of FIG. 1;

FIG. 8 is a cross-sectional side elevation view of the device of FIG. 1;

FIG. 9 is a cross-sectional side elevation view of a device according to an embodiment of the presently disclosed technology;

FIG. 10 is a cross-sectional side elevation view of a device according to an embodiment of the presently disclosed technology, where an irregularity of an existing pipe linear is depicted;

FIG. 11 is a cross-sectional elevational view taken along line A-A of FIG. 10;

FIG. 12 is a cross-sectional elevational view taken along line B-B of FIG. 10;

FIG. 13 is a perspective view of a device according to an embodiment of the presently disclosed technology;

FIG. 14 is a magnified perspective view of a portion of the device shown in FIG. 13;

FIG. 15 is another magnified perspective view of a portion of the device shown in FIG. 13;

FIG. 16 is a side elevation view of a portion of the device shown in FIG. 13;

FIG. 17 is a perspective view of the device shown in FIG. 13 within an interior liner of an underground pipe;

FIG. 18 is a cross-sectional elevation view of a device according to an embodiment of the presently disclosed technology attached to a tool or robot within an underground pipe;

FIG. 19 shows a cross-sectional elevation view of a portion of a device according to one embodiment of the presently disclosed technology, wherein a blade is shown mounted to a blade hub for a first interior diameter of a pipe or liner thereof;

FIG. 20 shows a cross-sectional elevation view of a portion of a device according to one embodiment of the presently disclosed technology, wherein a blade is shown mounted to a blade hub for a second interior diameter of a pipe or liner thereof;

FIG. 21 shows a cross-sectional elevation view of a portion of a device according to one embodiment of the presently disclosed technology, wherein a blade is shown mounted to a blade hub for a third interior diameter of a pipe or liner thereof;

FIG. 22 is a cross-sectional elevational view of a portion of a device according to one embodiment of the presently disclosed technology, from a perspective taken similar to or the same as along line B-B of FIG. 10, wherein a cover plate is shown and the device is shown in an off or resting position;

FIG. 23 is a cross-sectional elevational view of the portion of the device shown in FIG. 22, wherein the cover plate is omitted for clarity;

FIG. 24 is a cross-sectional elevational view of the portion of the device shown in FIG. 22, wherein the cover plate is shown and the device is shown in an on or working position; and

FIG. 25 is a cross-sectional elevational view of the portion of the device shown in FIG. 24, wherein the cover plate is omitted for clarity.

### DETAILED DESCRIPTION

While systems, devices and methods are described herein by way of examples and embodiments, those skilled in the art recognize that the systems, devices and methods of the presently disclosed technology are not limited to the embodiments or drawings described. Rather, the presently disclosed technology covers all modifications, equivalents and alternatives falling within the spirit and scope of the appended claims. Any headings used herein are for organizational purposes only and are not meant to limit the scope of the description or the claims.

Certain terminology is used in the following description for convenience only and is not limiting. The words “bottom.” “top.” “left,” “right,” “lower” and “upper” designate directions in the drawings to which reference is made. Unless specifically set forth herein, the terms “a,” “an” and “the” are not limited to one element but instead should be read as meaning “at least one.” As used herein, the word “may” and “can” is used in a permissive sense (i.e.., meaning having the potential to) rather than the mandatory sense (i.e., meaning must). The terminology includes the words noted above, derivatives thereof and words of similar import.

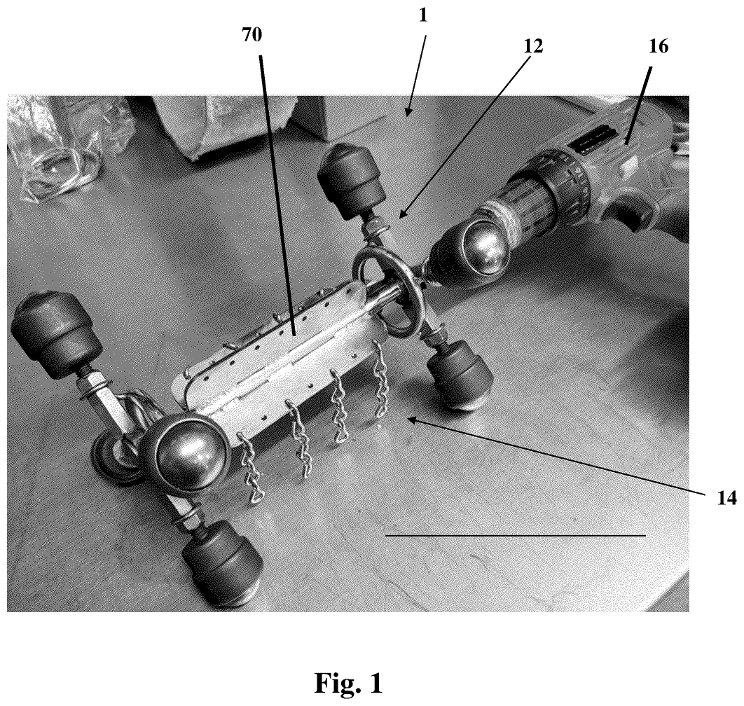

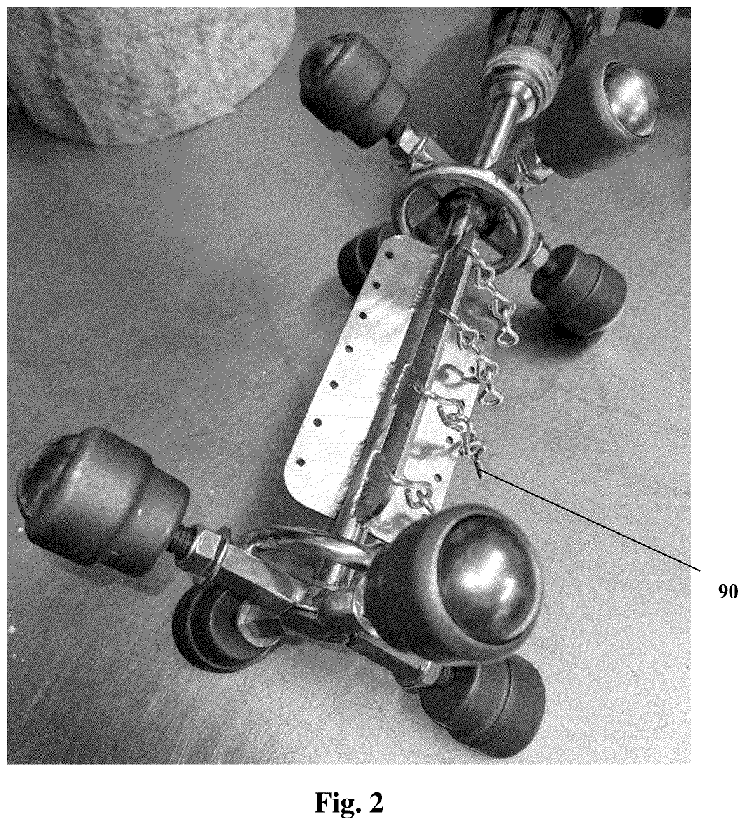

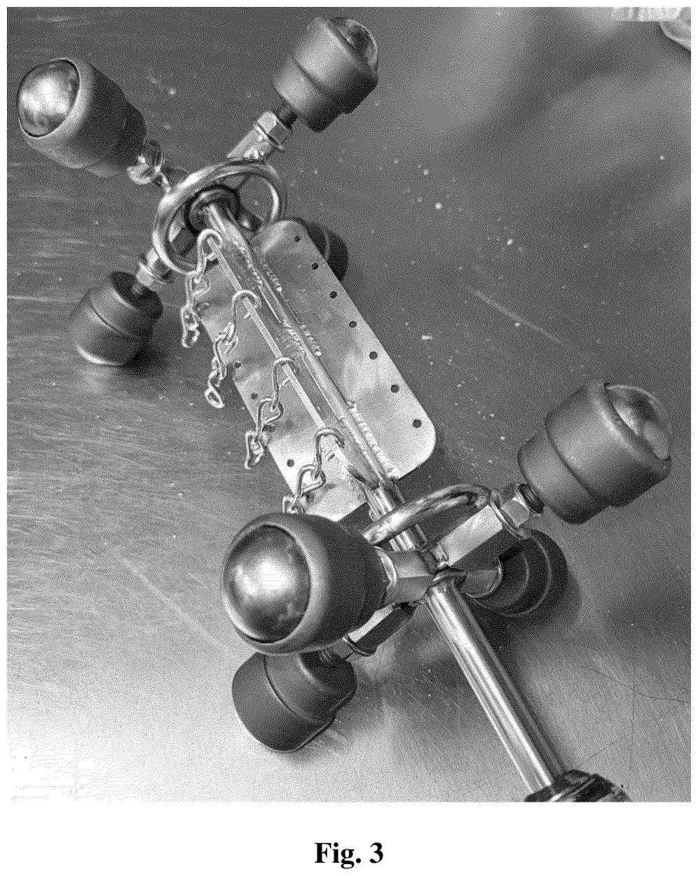

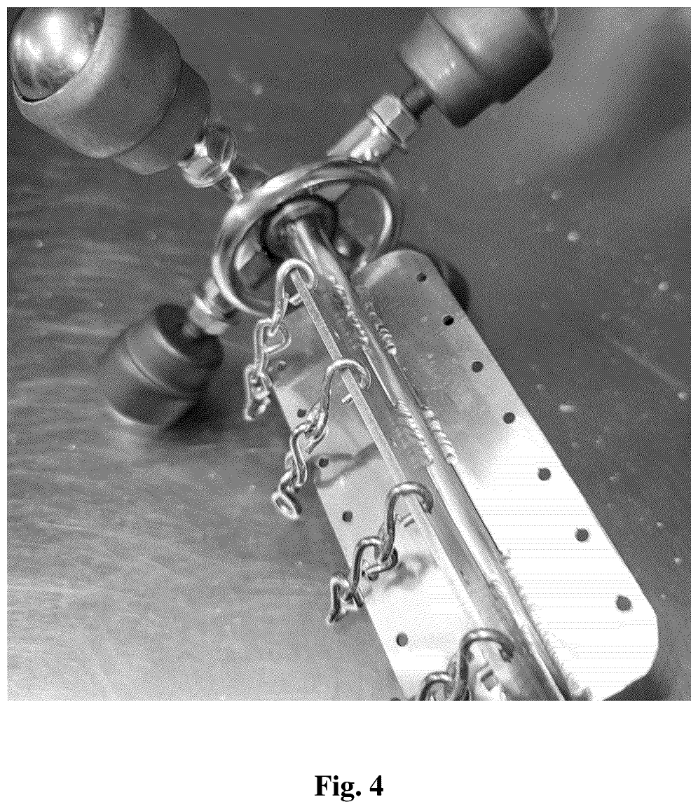

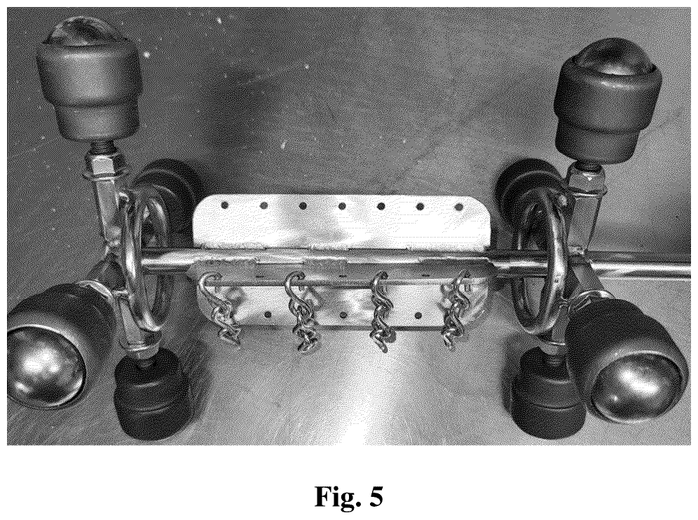

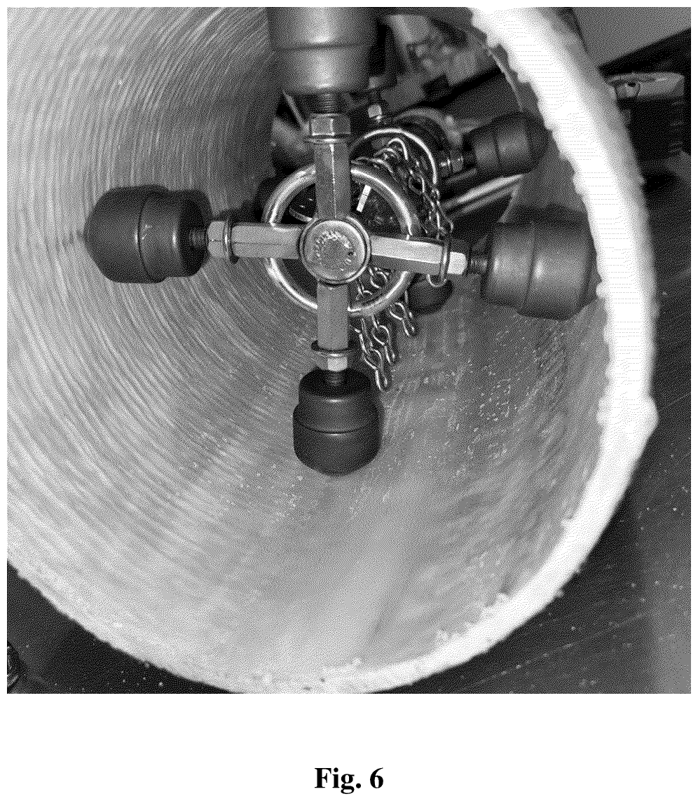

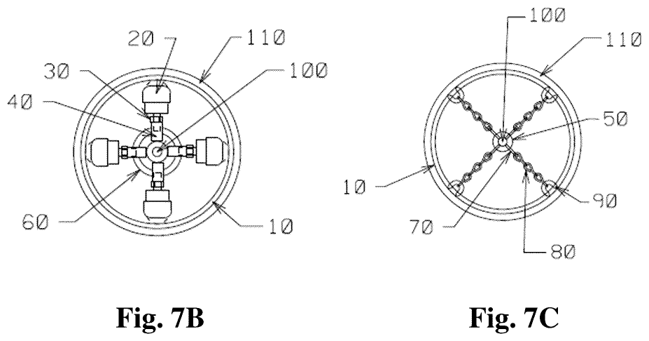

Referring to the drawings in detail, wherein like numerals indicate like elements throughout, FIGS. 1-8 show a device, generally designated 1, according to an optional embodiment of the presently disclosed technology. The device 1 can be configured to bore out or clean out a section of pipe 110, such as buried underground or in any other difficult-to-access location, and/or an interior liner 10 thereof without the need to dig out the section of pipe 110. This can allow for the removal of sections of an interior liner 10 and/or portions of an interior surface of the pipe 110 without causing structural damage to the pipe 110 and/or damage to an exterior surface of the pipe 110. As a result, liner 10 that incorrectly hardens, for example, can be removed prior to insertion or application of a new liner 10.

In one embodiment, the device 1 can include one, two, or a plurality of radially spaced-apart arms, generally designated 12, that extend radially outwardly from a central shaft 100. Optionally, a radial length of each arm 12 is adjustable, for example manually or automatically (e.g., spring loaded or telescoping). In another optional embodiment, a radial length of each arm 12 is fixed, and each arm 12 can be attached to the central shaft by one or more fasteners.

One end (e.g., a proximal end) of the central shaft 100 can be attached or removably attachable to a tool 16 (see FIG. 1). The tool 16 can optionally be a pneumatic or rotary tool, such as a drill, that can include a motor, or any other type of spinning tool.

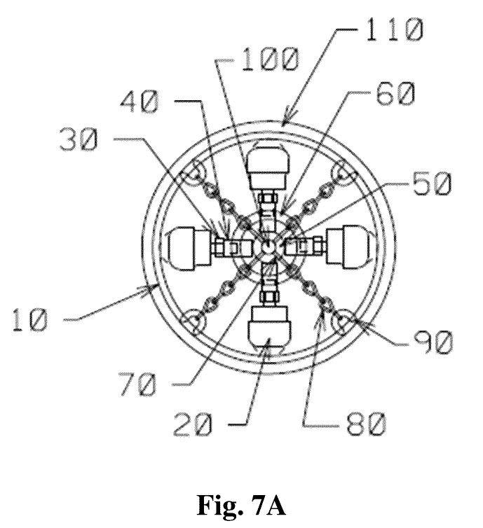

Optionally, each arm 12 can be rotatably attached to the central shaft 100, meaning as the central shaft 100 rotates along its central axis or the longitudinal axis of the pipe 110 or the interior liner 10 thereof (e.g., extending into or out of the page at the center of the circle in FIGS. 7A-7C) in a clockwise or counterclockwise direction, each arm 12 can maintain its original position and or radially length. Thus, each arm 12 can rotate independent from any rotation of the central shaft 100. In one embodiment, at least one bearing 50 is located between and attaches each arm 12 to the central shaft 100. The bearing 50 can be press fit or welded onto the central shaft 100. The bearing 50 can allow the central shaft 100 to spin freely with respect to the arm 12.

In one optional embodiment, the device 1 can include more than one set of plurality of arms 12. For example, the device 1 can optionally include a first set of a plurality of arms 12 that can include four radially spaced-apart arms 12. The device 1 can also optionally include a second set of a plurality of arms 12. The second set can be comprised of optionally four radially spaced-apart arms 12. The first set can be spaced-apart from the second set along the central axis of the central shaft 110 or the longitudinal axis of the pipe 110 or the interior liner 10 thereof.

In one embodiment, as shown in FIG. 1, the device 1 can include two or more or a plurality of radially spaced-apart cutting devices, generally designated 14, that extend radially outwardly from the central shaft 100. The cutting devices 14 can be positioned between the first and second set of a plurality of arms 12.

Optionally, a first end of each cutting device 14 is configured to move in unison with the central shaft 100. An opposing second end of each cutting device 14 is moveable with respect to the central shaft 100. Rotation of the central shaft 100 can cause the second end of each cutting device 14 to contact and cut an interior surface of the pipe 110 or an interior liner 10 thereof. The liner 10 can be formed of fiberglass or other material.

In one optional embodiment, at least two or a plurality of spaced-apart fins 70 can extend radially outwardly from the central shaft 100. Each fin 70 can optionally be fixed with respect (e.g., welded) to the central shaft 100, meaning as the central shaft 100 rotates along the longitudinal axis in a clockwise or counterclockwise direction, so does each fin 70. In another embodiment, each fin 70 is removably fastened to the central shaft 100. Optionally, the fins 70 can be positioned between two sets of arms 12 along the longitudinal axis. In one embodiment, each fin 70 can include two or more or a plurality of spaced-apart holes at or near an end opposite the central shaft 100.

Each cutting device 14 can be directly attached, or optionally removably fastened, to one of the fins 70. In one optional embodiment, each fin 70 is attached to four spaced-apart cutting devices 14 that extend along the longitudinal axis. Each cutting device 14 can include a holding chain 80 and a cutting end 90. A first or proximal end of each holding chain 80 can be attached, either removably or permanently, to one of the fins 70, optionally through one of the holes. A second or distal end of each holding chain 80 can be attached to one of the cutting ends 90.

Optionally, each holding chain 80 can be formed by two or more links of a chain depending on length requirements. Each cutting end 90 can have at least one sharp blade or edge designed to remove or scrape against the interior of the pipe 110 or a linear 10 thereof. The cutting ends 90 are shown as having a U-shaped configuration, but other sizes, shapes, and configurations are possible. For example, adjacent cutting ends 90 can have different configures, such as pointed and/or flat tips.

Each arm 12 can be self-adjusting or automatic-adjusting to the interior of the pipe 110 or the interior liner 10 thereof. For example, as shown in FIGS. 7A, 7B, and 8-10, each arm 12 can optionally include a fastening coupler \grave{ }, a locking nut 30, and a roller 20. The fastening coupler 40 of each arm 12 can be welded to the bearing 50. The locking nut 30 can allow the user or operator to ensure that the roller 20 does not loosen under stress. The roller 20 can be adjustable and/or centering, which ensures that the device 1 is properly centered within the section of the pipe 110 so that the cutting devices 14 do not remove more material (e.g., of the pipe 110 or the liner 10) than desired or required.

Optionally, each roller 20 can include a spacer, a spring, and/or a thumb screw within a hub assembly to allow for self-adjustment or automatic-adjustment.

In one embodiment, each set of a plurality of arms 12 can include an optional stiffening ring 60. The stiffening ring 60 can contact or be attached to each arm of the set. The stiffening ring can optionally be welded to each fastening coupler 40 to lock all of the arms 12 and/or the rollers 20 from moving with respect to each other.

In operation, the device 1 can be inserted into an interior of a pipe 110 that requires attention or is debilitated. The device 1 can be properly aligned by having the roller 20 of each arm 12 contact an interior surface of the pipe 110 or the liner 10. Each arm 12 can have the same length, or the arms 12 can be adjusted to have the same length, such that the central shaft 100 of the device 1 is co-linear with the longitudinal axis of the section of the pipe 110 or situated as required for other uses.

Next, the central shaft 100 of the device 1 can be rotated with respect to the pipe 110 or the liner 10 such that the arms 12 maintain the central shaft 100 co-linear with the longitudinal axis of the section of the pipe 110. The central shaft 100 can be rotated by connecting a proximal end thereof to the tool 16, for example. The cutting devices 14 rotate as the central shaft 100 is rotated, thereby causing each cutting end 90 to contact the interior surface of the pipe 110 and/or the liner 10. During this time, the arms 12 can optionally remain stationary with respect to the pipe 110.

After a sufficient time and/or number of rotations of the central shaft 100, the cutting ends 90 have cut or scrapped a sufficient or predetermined amount of the interior surface of the pipe 110 and/or the existing liner 10 to make room for a new liner to be applied.

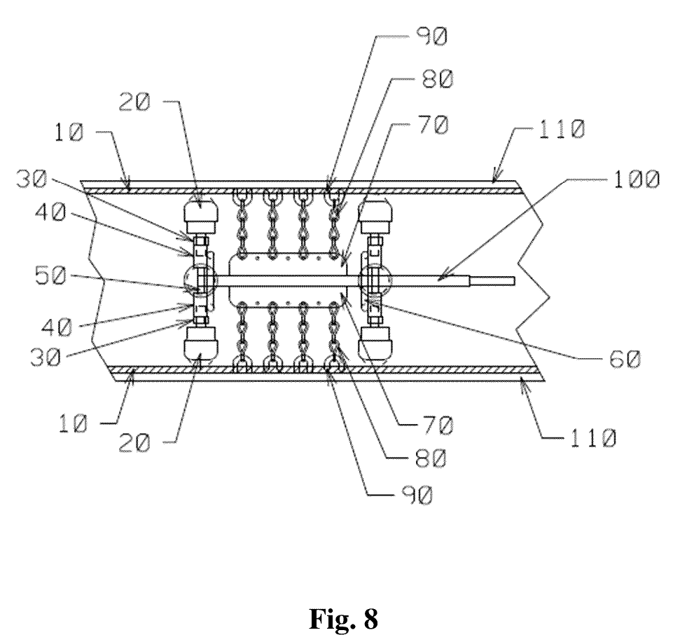

FIG. 9 shows a modified version of the device 1. The two versions are substantially similar, and like elements between the two embodiments are identified with like reference numbers, and description of certain similarities between the two embodiments may be omitted herein for brevity purposes only. Items within either version can be interchanged with items in the other version.

Optionally, each arm 12 is positioned distally with respect to the fins 70 from the tool.

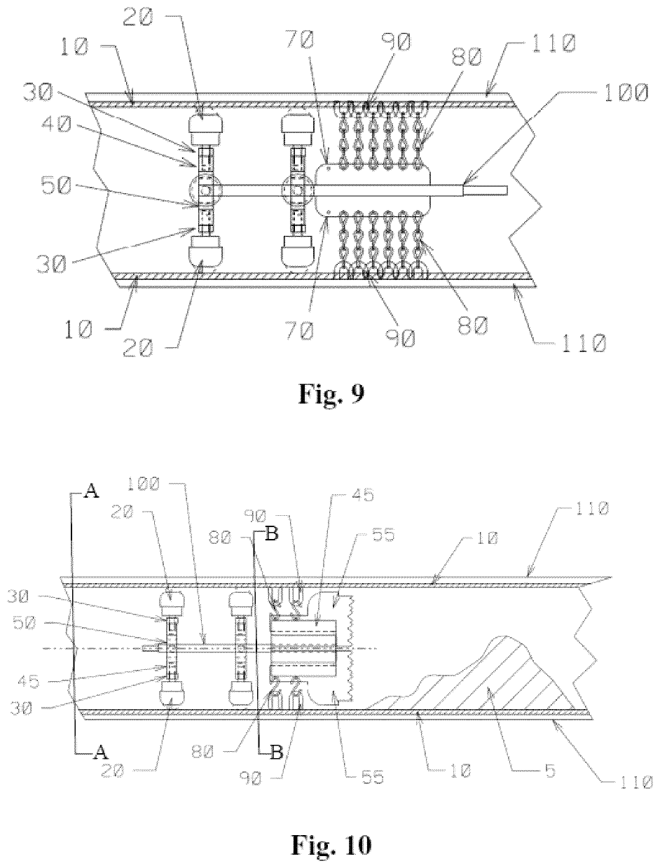

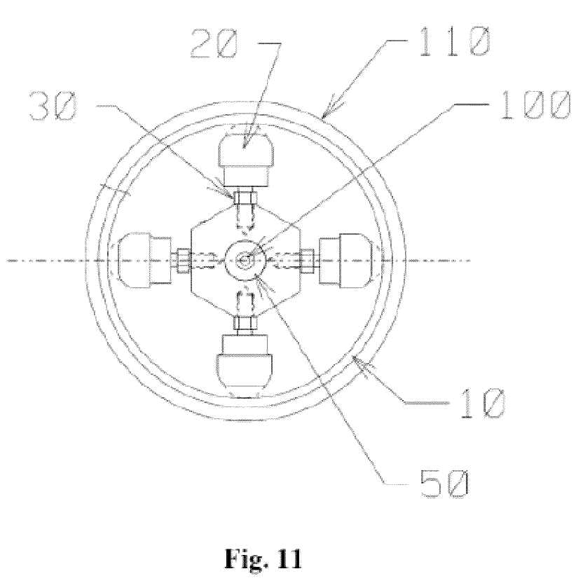

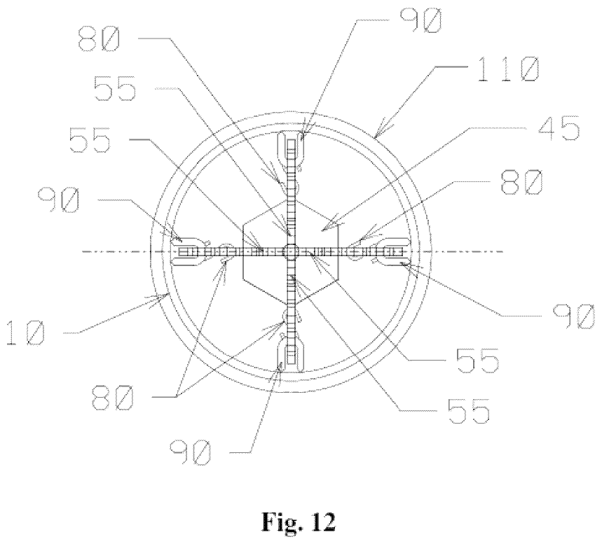

FIGS. 10-12 show another modified version of the device 1. The three versions are substantially similar, and like elements between the three embodiments are identified with like reference numbers, and description of certain similarities between the three embodiments may be omitted herein for brevity purposes only. Items within one version can be interchanged with items in either or both of the other versions.

FIG. 10 depicts how a liner 10 can incorrectly harden or bulge (e.g., identified by raised portion 5 and commonly referred to as a “lift”) inside of the pipe 110. The bulge 5 must be removed or significantly reduced to allow for a new liner 10 to be installed properly. To accomplish this, the device 1 can include one or more blades 55 extending forward from, and optionally fixedly attached to (e.g., via welding) or removably fastened to a center or blade hub 45. In one embodiment, each blade 55 may include one or more holes or slots to attached to the cutting device(s) 14. Optionally, the center or blade hub 45 can replace the fins 70 described above. The chain(s) 80 and cutting end(s) 90 can extend from and/or be attached to the center or blade hub 45. The center or blade hub 45 can be fixedly attached (e.g., via welding) or removably fixed to the distal end of the central shaft 100 and/or the bearing 50.

Optionally, each blade 55 can include one or more slots configured to receive a fastener (e.g., a bolt) to attach the blade 55 to the blade hub 45. Each slot can be elongated (e.g., oval) or eccentric in shape so that each blade 55 can be manually adjustable. Alternatively, in one optional embodiment, each blade 55 can have rounded stops at back edges to allow the blade 55 to slide and/or expand outward with centrifugal force so that each blade 55 is self-adjusting.

In operation, the one or more blades 55 can be rotated with the central shaft 100 to cut the majority or entirety of the bulge 5 of the liner 10. The cutting ends 90 can create finer or more precise cuts, if desired or necessary.

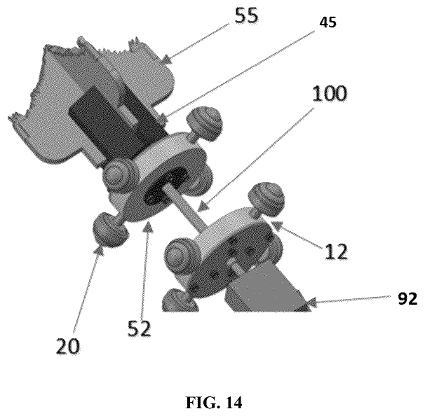

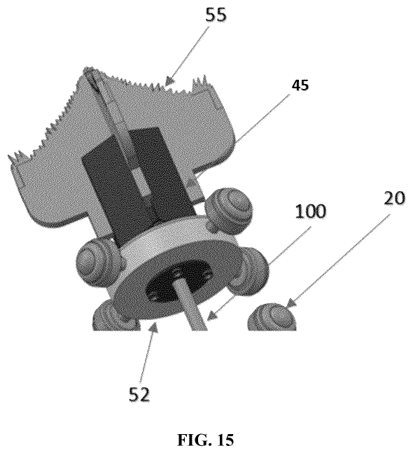

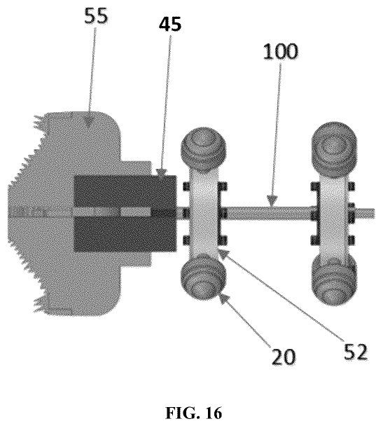

As shown in FIGS. 10, 11, and 13-18, each arm can be attached to a spring hub 52 instead of or in addition to the fastening hub 40 of a previous embodiment. Optionally, the spring hub 52 can include at least one spring therein, or a spring for each of the arms attached thereof. For example, each spring can be a coil spring within a plurality of spaced-apart slots around a periphery of the spring hub. Each spring allows the respective arm 12 to move radially inward and outward, at least slightly, to accommodate changes in the interior of the pipe 110 and/or the interior liner 10 thereof, while still maintaining the blades and/or cutting elements centered within the pipe 110 and/or the interior liner 10 thereof.

Alternatively, the spring hub 52 can be devoid of any springs, such that each arm is fixed to the hub.

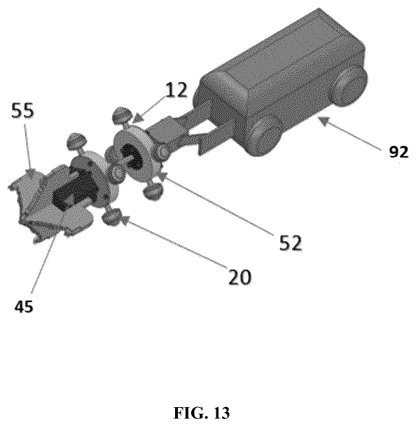

FIGS. 13-17 show another modified version of the device 1. The four versions are substantially similar, and like elements between the four embodiments are identified with like reference numbers, and description of certain similarities between the four embodiments may be omitted herein for brevity purposes only. Items within one version can be interchanged with items in either or both of the other versions.

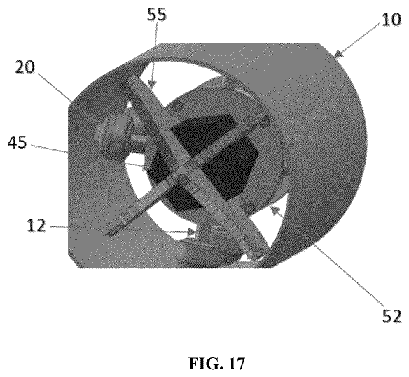

A distinguishing feature of the embodiment shown in FIGS. 13-17 is the omission of the chain-form of cutting devices 14 from the previous embodiments and reliance upon the at least one cutting element in the form of a blade 55 that extends outwardly from the distal end of the central shaft. In one embodiment, as shown in FIG. 17, the cutting device optionally includes at least two blades 55 that extend at angles of 90 degrees or 45 degrees to one another. Each blade 55, which can be devoid of any holes therein, can move in unison with the central shaft 100, and the hub 45 that connects the central shaft 100 to each blade 55. The hub 45 is shown to be a three dimensional hexagon in FIG. 17, but other sizes, shapes, and configurations are possible.

When viewed along the central axis of the central shaft 100, optionally two or four of the blades 55 can form an X shape. A front end of each blade 55 can include teeth in an undulating or non-linear pattern. Each blade 55 can optionally be removably or fixedly mounted to the central shaft 100. A radial length of each blade 55 can optionally be at least slightly less than a radius of the pipe 10 or the interior liner 110 thereof. Also, each blade 55 can optionally be self-adjusting or automatic-adjusting to the interior diameter of the pipe 10 or the interior liner 110 thereof, while still maintaining the blades and/or cutting elements centered within the pipe 110 and/or the interior liner 10 thereof.

Another distinguishing feature of this embodiment is that one end (e.g., the proximal end) of the central shaft 100 can be fixedly or removably attachable to a robot 92. The robot 92 can be configured to push and/or pull the device along the longitudinal axis of the underground pipe 110 or the interior liner 10 thereof. The robot 92 can house a motor and can include one or more (e.g., four spaced-apart) wheels that contact an interior of the pipe 110 or the interior liner 10 thereof to move the device within the pipe 110 or the interior liner 10 thereof. The robot 92 can be operatable connected or include video equipment (e.g., a camera capable of video feed and/or recording) to allow the user or operator to see the interior of the pipe 110 or the interior liner 10 thereof.

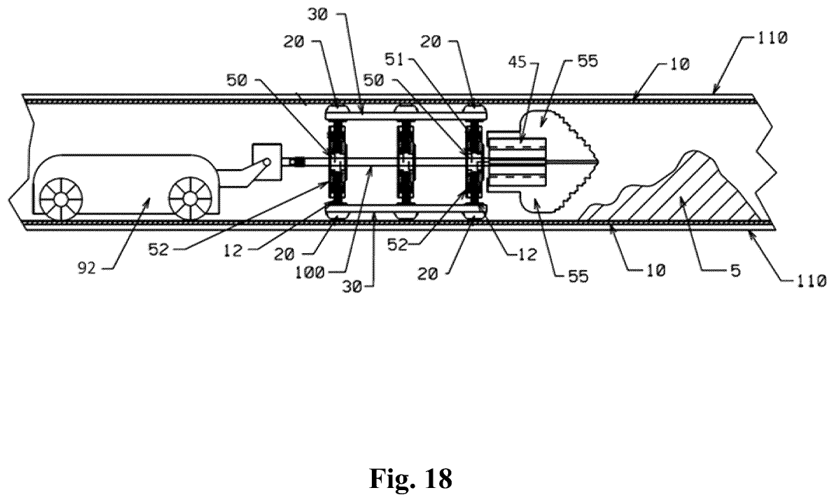

FIG. 18 shows another modified version of the device 1. The five versions are substantially similar, and like elements between the five embodiments are identified with like reference numbers, and description of certain similarities between the five embodiments may be omitted herein for brevity purposes only. Items within one version can be interchanged with items in either or both of the other versions.

A distinguishing feature of the embodiment shown in FIG. 18 is a third set of a plurality of arms 12.

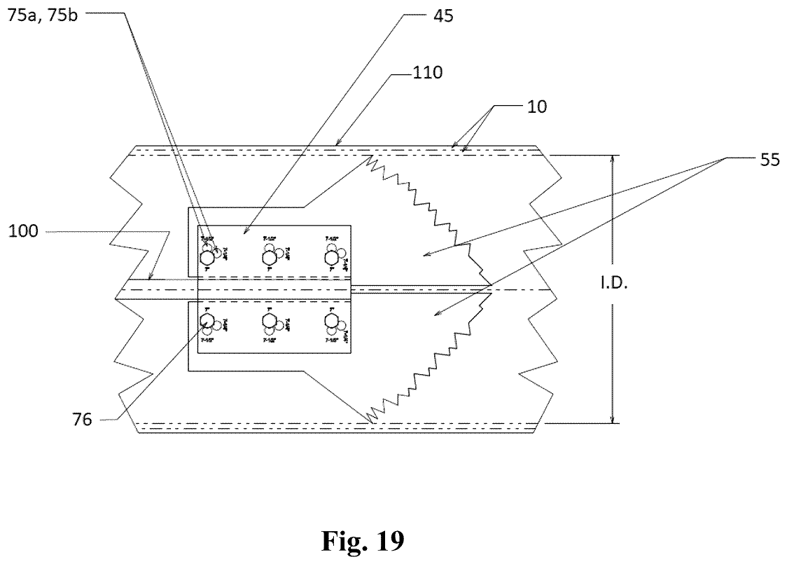

FIGS. 19-21 show one optional aspect of the presently disclosed technology, where each blade 55 can be manually adjusted. Each blade 55 can include two, three, or more at least slightly spaced-apart holes, such as first hole 75a, second hole 75b, and third hole 75c, to receive a fastener 76 (only the head of the fastener 76 is visible in these figures, as the shaft of the fastener 76 would extend into the page) therethrough to attach the blade 55 to the blade hub 45. Repositioning of the fasteners 76 through one of the various holes through the blade 55 and into the blade hub 45 modifies or adjusts extend to which the outer edge of the blade 55 contacts or approaches the interior of the pipe 110 or the interior liner 10 thereof.

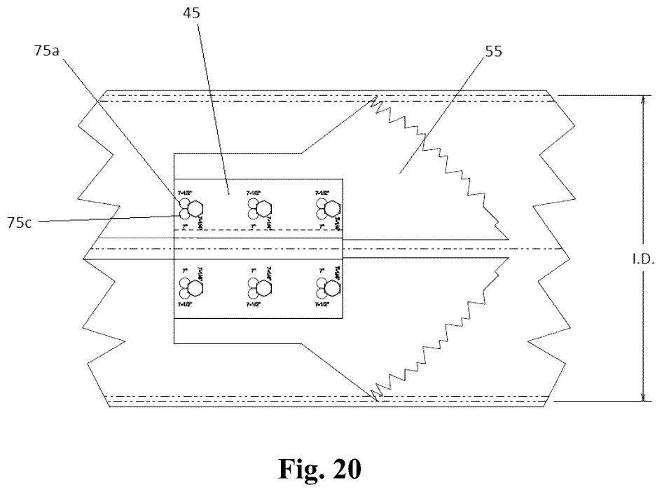

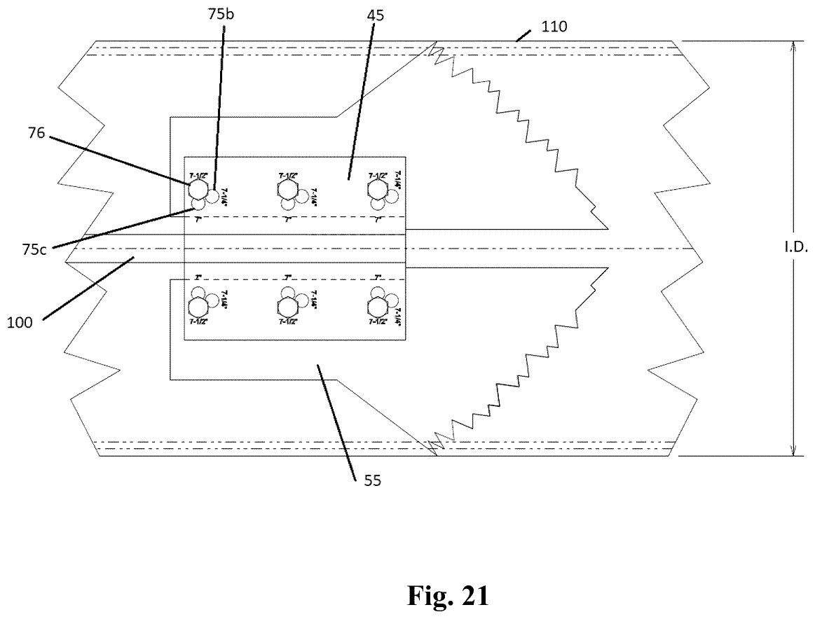

FIG. 19 shows two blades 55 adjusted or positioned for an interior diameter (I.D.) of the pipe 110 or the interior liner 10 thereof of 7 inches. FIG. 20 shows two blades 55 adjusted or positioned for an interior diameter of the pipe 110 or the interior liner 10 thereof of 7.25 inches. FIG. 21 shows two blades 55 adjusted or positioned for an interior diameter of the pipe 110 or the interior liner 10 thereof of 7.5 inches. Each of these figures show optional dimensions, as different embodiments are possible for different internal diameters of the pipe 110 or the interior liner 10 thereof.

When comparing FIGS. 19-21, it is apparent that in FIG. 19 the blades 55 are closest to the central shaft 100 and furthest from the interior of the pipe 110 or the interior liner thereof 10, and in FIG. 21 the blades 55 are closest to the interior of the pipe 110 or the interior liner thereof 10. Alternatively or additionally, the configuration shown in FIG. 19 can be used for a pipe 110 or liner 10 with the smallest interior diameter, and the configuration shown in FIG. 21 can be used for a pipe 110 or liner 10 with the largest interior diameter. The presently disclosed technology can be made to accommodate a variety of interior diameter ranges. For example, the blades 55 can be adjustable to work between 7-7.5 inch interior diameter, 7.5-8 inch interior diameter, 8-8.5 inch interior diameter, and so on.

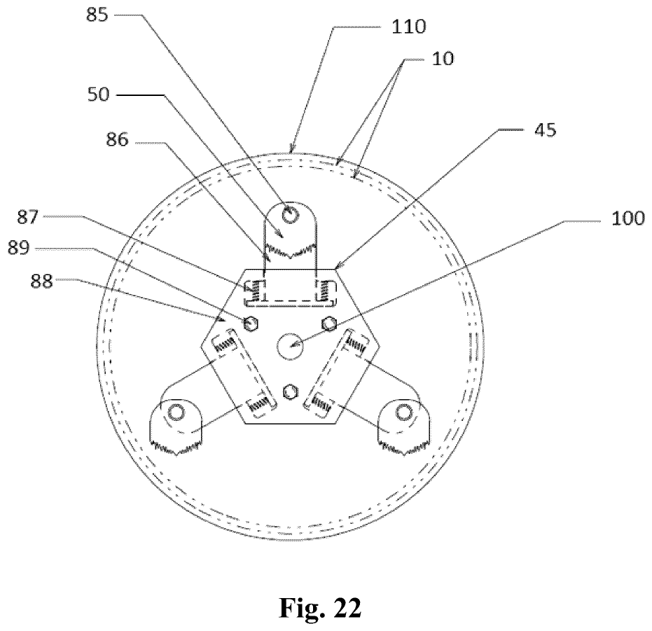

FIGS. 22-25 show one optional aspect of the presently disclosed technology, where each blade 55 is self or automatically adjusted. For example, each blade 55 can be pivotally attached, such as by a fastener 85, to a self-adjusting blade arm 86. Each blade arm 86 can be movably attached to the blade hub 45, which is rotatably or fixedly attached (e.g., welded) to the central shaft 100, by at least one or two spaced-apart biasing members or retracting springs 87. The retracting springs 87 can allow the blade arms 86 to move toward and away from the central shaft 100 and/or the blade hub 45. As described above, the central shaft 100 can be fastened or attached to a robot or a rotary tool.

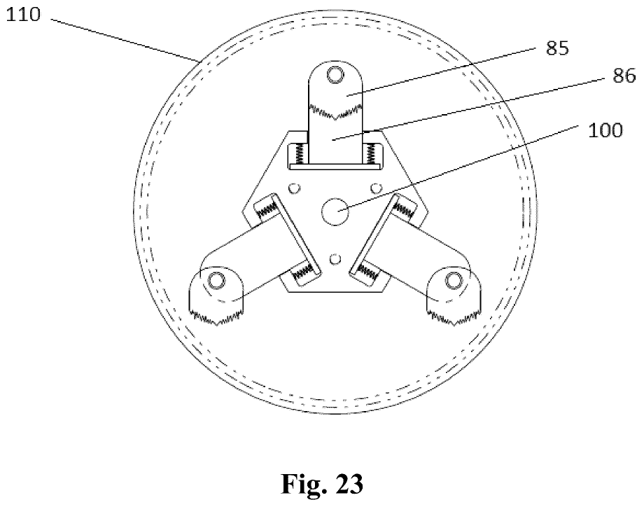

FIG. 22 shows the arrangement in a resting or not spinning configuration (i.e., not in use), with a cover plate 88 attached to the blade hub 45 by a plurality of spaced-apart fasteners 89. The cover plate 88 is configured to cover and/or protect certain parts (e.g., the blade hub 45), and/or seal and keep clean the inside of the blade hub 45. FIG. 23 omits the cover plate 88 for clarity and also shows the arrangement in the resting or not spinning configuration. When at rest, each blades 55 can swing downward due to gravity, which makes the assembly smaller to facilitate the insertion into the pipe 110 and/or the interior liner 10 thereof before usage.

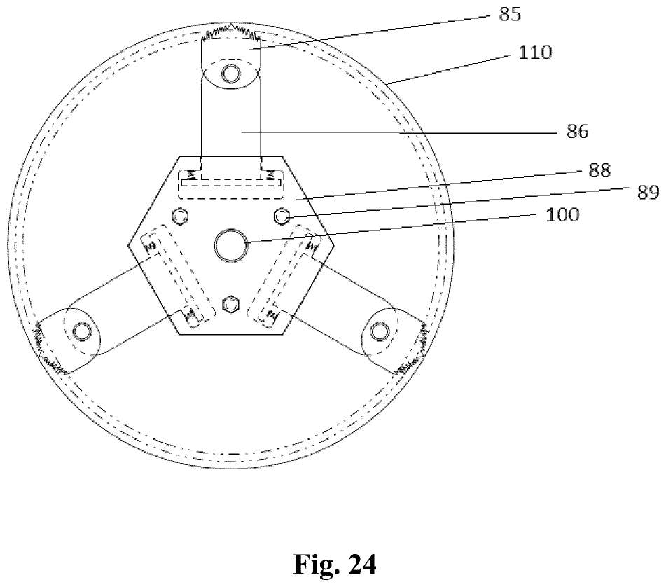

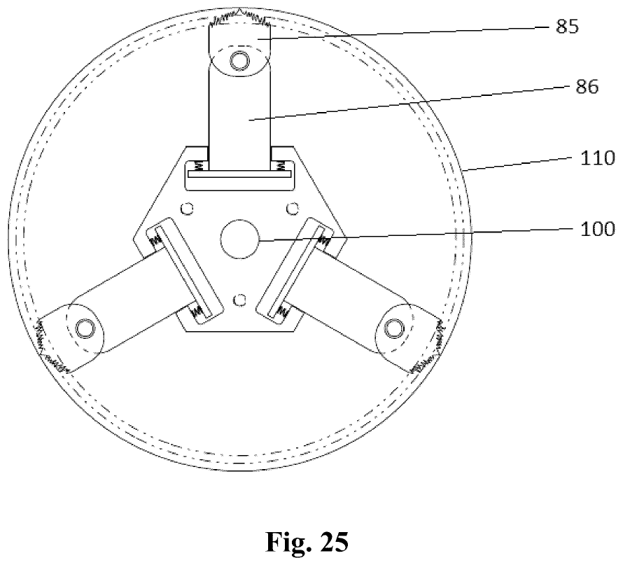

FIG. 24 shows an arrangement with three spaced-apart blades 55 while spinning (i.e.., when in use). The cover plate 88 is shown in FIG. 24. FIG. 25 also shows the spinning arrangement, but with the cover plate 88 omitted for clarity.

Optionally, each blade arm 86 is pushed toward the central shaft 100 with springs or magnets, thus increasing the distance between an end of each blade 55 and the interior of the pipe 110 or the liner 10 thereof. The springs or magnets are sufficiently strong to keep the weight of each blade 55 and the arms 86 tucked toward the center. The springs or the magnets need very little pull to allow the blades 55 to protrude outwardly to allow the blades 55 to cut the interior of the pipe 110 and/or the liner 10 thereof.

In one optional operation, the robot or tool is pushed into the pipe 110 and/or the liner 10 without the robot or tool rotating to a point in the pipe 110 and/or the liner 10 that needs to be addressed. Once in place, the robot or tool begins to spin, which in turn rotates the center shaft 100. Once the center shaft 100 spins, the blade arms 86 begin to spin, and each blade 55 is forced and/or rotated outwardly by centrifugal force. The expansion or rotation of the blades 55 outward is dependent upon revolutions supplied by the robot or tool. Once the cutting has finished, the robot or tool stops the rotation of the central shaft 100, allowing all springs and gravity to retract blades 55 back toward the central shaft 100, allowing the entire tool to be pulled back out of the pipe 110 and/or the liner 10 thereof without obstructions.

Even if it is interpreted that multiple embodiments are shown and/or described herein, it is understood that any one or more features of any particular embodiment can be omitted or included in (e.g., added to) another embodiment. For example, portions of the device may be interchangeable with one or more fasteners.

The following exemplary embodiments further describe optional aspects of the presently disclosed technology and are part of this Detailed Description. These exemplary embodiments are set forth in a format substantially akin to claims, although they are not technically claims of the present application. The following exemplary embodiments refer to each other in dependent relationships as “embodiments” instead of “claims.”
1A. A device comprising a plurality of arms extending radially outwardly from a central shaft and a plurality of cutting devices extending radially outwardly from the central shaft, wherein the arms rotate independent of the central shaft and the cutting devices rotate with the central shaft.
1B. The device embodiment 1A, wherein a length of each arm is fixed or adjustable.
1C. The device of embodiment 1A or 1B, wherein a length of each cutting device is adjustable.
1D. The device of any one of embodiment 1A-1C, wherein the plurality of arms includes a first set of a plurality of arms and a second set of a plurality of arms, wherein the plurality of cutting devices is positioned between the first and second set.
2A. A combination tool and device configured to removably attach to the tool and configured to be insertable into an existing underground pipe to remove incorrectly hardened portion of pipe liners or bore out an interior surface of the underground pipe or an interior liner thereof.
2B. The combination of embodiment 2A, wherein inertial or centrifugal force causes cutting devices to scrape or cut the interior surface of the underground pipe or the interior liner thereof.
3A. A method of removing or replacing an interior liner of a debilitated underground pipe, the method comprising inserting into the underground pipe a device that cuts an interior surface of the liner while the device is maintained along a central longitudinal axis of the device.

It will be appreciated by those skilled in the art that changes could be made to the embodiments described above without departing from the broad inventive concept thereof. It is understood, therefore, that the presently disclosed technology is not limited to the particular embodiments disclosed, but it is intended to cover modifications within the spirit and scope of the presently disclosed technology as defined by the appended claims.

What is claimed is:

1. A device configured to cut or bore out underground pipe or an interior liner thereof, the device comprising:
a central shaft having a proximal end, an opposing distal end, and a central axis extending therebetween, the central axis being configured to extend along a longitudinal axis of at least a section of an underground pipe or an interior liner thereof, the proximal end of the central shaft being attachable to a tool or robot, the central shaft being configured to be rotated by the tool or robot around the central axis thereof;
a plurality of arms extending radially outwardly from the central shaft, each of the plurality of arms between positioned along the central shaft between the proximal and distal ends thereof; and
at least one cutting device extending radially outwardly from the distal end of the central shaft, the at least one cutting device being configured to rotate with the central shaft, rotation of the central shaft causing the at least one cutting device to contact and cut an interior surface of the underground pipe or the interior liner thereof.

2. The device of claim 1, wherein a hub connects the at least one cutting device to the central shaft, and wherein the central shaft, the hub, and the at least one cutting device being configured to move in unison.

3. The device of claim 2, wherein a blade arm connects each cutting device to the hub, wherein each cutting device is rotatable about a fastener extending through the cutting device and the respective blade arm.

4. The device of claim 3, wherein at least one retracting spring is attached to each blade arm and the hub.

5. The device of claim 1, wherein each of the plurality of arms being rotatable with respect to the central shaft.

6. The device of claim 5, wherein each of the plurality of arms is self-adjusting.

7. The device of claim 1, wherein each of the plurality of arms is attached to a bearing that is operatively connected to the central shaft.

8. The device of claim 7, wherein each of the plurality of arms includes a fastening coupler, a locking nut, and a roller.

9. The device of claim 8, wherein each roller is an adjustable and centering roller.

10. The device of claim 1, wherein the device is configured to bore out at least a section of the underground pipe or the interior liner thereof without the need to dig out the section of pipe.

11. The device of claim 1, wherein the plurality of arms includes a first set of plurality of arms and a second set of plurality of arms, the first set of plurality of arms being closer to the proximal end of the central shaft than the second set of plurality of arms.

12. The device of claim 11 wherein the plurality of arms includes a third set of plurality of arms.

13. The device of claim 1, wherein the at least one cutting device includes at least two blades extending at angles of 90 degrees or 45 degrees to one another.

14. The device of claim 2, wherein the at least one cutting device includes at least two blades, each blade being removably attachable to the hub.

15. The device of claim 1, wherein the tool is a pneumatic or rotary tool.

16. A method of reducing or removing one or more lifts from an interior liner of a section of underground pipe, the method comprising:
inserting a device into the interior liner of the underground pipe, a proximal end of a central shaft of the device being attached to a tool or robot configured to rotate the central shaft about its central axis;
aligning the central shaft of the device with a longitudinal axis of the underground pipe; and
causing the tool or robot to rotate the central shaft, thereby causing at least one blade attached to or near a distal end of the central shaft to rotate within the underground pipe or the interior liner thereof to reduce or remove one or more lifts.

17. The method of claim 16, wherein a plurality of arms that are rotatably attached to the central shaft to center the device within the underground pipe or the interior liner thereof.

18. The method of claim 16, further comprising:
accessing video capabilities of the tool or robot to display portions of the underground pipe or the interior liner thereof above ground.

19. The method of claim 16, the method further comprising pushing the tool or robot to move the device along the longitudinal axis of the underground pipe or the interior liner thereof.

20. The method of claim 16, the method further comprising allowing each blade to rotate outwardly with respect to the central shaft when the tool or robot rotates the central shaft.
